(19) United States
(12) Patent Application Publication
(10) Pub. No.: US 2013/0338963 A1
(43) Pub. Date: Dec. 19, 2013

(54) INPUT MECHANISM, INPUT DEVICE AND INPUT MECHANISM CONTROL METHOD

(71) Applicant: Kazuhito Murata, Tokyo (JP)

(72) Inventor: Kazuhito Murata, Tokyo (JP)

(73) Assignee: NEC CORPORATION, Minato-ku, Tokyo (JP)

(21) Appl. No.: 14/001,525

(22) PCT Filed: Nov. 15, 2011
(86) PCT No.: PCT/JP2011/076743

§ 371 Date: Aug. 26, 2013

(30) Foreign Application Priority Data
Mar. 1, 2011 (JP) 2011043743

(51) Int. Cl. G05B 11/36

(52) U.S. Cl. CPC G05B 11/36
USPC 702/142

(57) ABSTRACT

An input mechanism capable of providing a sense of touch according to an input operation to a user is provided.

An input mechanism of the present invention includes: an indicating tool detecting unit arranged in a predetermined area to detect existence of an indicating tool on the predetermined area; an elastic member arranged in an area circled by the indicating tool detecting unit; a pressing detection unit to detect the elastic member having been pressed; a calculation unit to calculate a moving speed of the indicating tool from a detection result by the indicating tool detecting unit and a detection result by the pressing detection unit; a signal output unit to output a drive signal, upon the pressing detection unit detecting the elastic member having been pressed; and a driving unit to apply a force to the elastic member by carrying out driving based on the drive signal. The signal output unit changes the drive signal to be outputted based on a moving speed calculated by the calculation unit.

### TECHNICAL FIELD

The present invention relates to an input mechanism, an input device and an input mechanism control method.

### BACKGROUND ART

Generally, in relatively small electronic equipment such as a Personal Digital Assistance, there is used a mechanical switch such as a membrane switch and a tactile switch as an input device for a user. However, it is difficult for a mechanical switch to be made small-sized and thin. In addition, feeling when pressing a switch is determined by the physical structure itself of the switch. Therefore, it is difficult to customize a sense of touch in conformity to a user's taste, or to change a sense of touch of an identical switch according to the situation.

On the other hand, in recent years, a touch panel is widely used. A touch panel enables trigger input to electronic equipment only by touching by a finger or the like. Other than a Personal Digital Assistance, a touch panel is also used in a display for car navigation, a ticket vending machine in a railway station, an ATM (Automated teller machine) of a bank and the like.

For example, a technology about a touch panel is disclosed in Japanese Patent Application Laid-Open No. 2003-288158 (patent document 1). In portable equipment described in patent document 1, a sense of feedback is given to a user's fingertip by burying a force sensing device in a touch panel type display. However, in portable equipment disclosed in patent document 1, turning on/off of a switch is made by a simple trigger input, that is, input of a manipulate signal. Therefore, it is not a kind that inputs a manipulate signal according to an input operation such as a movement of a finger. Also, it does not change a sense of touch according to an input operation, and thus operability is not necessarily good for a user.

An input device that changes a sense of touch according to an input operation is disclosed in Japanese Patent Application Laid-Open No. 2005-352927 (patent document 2), for example. The input unit described in patent document 2 has: a sensor which generates a detection signal according to a pressing force; and a sensor which determines a pressing force from the detection signal which the former sensor has generated. Then, a drive signal according to the pressing force is supplied to an actuator which makes a chassis vibrate.

### DISCLOSURE OF THE INVENTION

### Problems to be Solved by the Invention

However, an input device described in patent document 2 is not a device that changes a sense of touch according to an input operation by an indicating tool such as a finger and a stylus pen: a moving speed, for example.

In view of the above-mentioned problem, an object of the present invention is to provide an input mechanism capable of presenting a sense of touch according to an input operation to a user.

### Means for Solving the Problem

An input mechanism of the present invention, comprises: an indicating tool detecting unit, arranged in a predetermined area, to detect existence of an indicating tool on the predetermined area; an elastic member arranged in an area circled by the indicating tool detecting unit; a pressing detection unit to detect the elastic member being pressed; a calculation unit to calculate a moving speed of the indicating tool from a detection result by the indicating tool detecting unit and a detection result by the pressing detection unit; a signal output unit to output a drive signal, upon the pressing detection unit detecting the elastic member being pressed; a driving unit to apply a force to the elastic member by carrying out driving based on the drive signal; and the signal output unit changes the drive signal to be outputted based on a moving speed calculated by the calculation unit.

An input device of the present invention includes a plurality of input mechanisms of the present invention.

An input mechanism control method of the present invention, comprises: an indicating tool detection step of detecting an indicating tool existing on a predetermined area; a pressing detection step of detecting an elastic member, arranged in an area circled by the predetermined area, having been pressed; a calculating step of calculating a moving speed of the indicating tool from a detection result by the indicating tool detection step and a detection result by the pressing detection step; a signal output step of outputting a drive signal, upon detecting the elastic member having been pressed by the pressing detection step; a signal output step of outputting a drive signal, upon detecting the elastic member having been pressed by the pressing detection step; the signal output step changing the drive signal based on a moving speed calculated by the calculating step.

A program according to the present invention makes a computer carry out: an indicating tool detection step of detecting an indicating tool existing on a predetermined area; a pressing detection step of detecting an elastic member, arranged in an area circled by the predetermined area, having been pressed; a calculating step of calculating a moving speed of the indicating tool from a detection result by the indicating tool detection step and a detection result by the pressing detection step; a signal output step of outputting a drive signal, upon detecting the elastic member having been pressed by the pressing detection step; a driving step of applying a force to the elastic member by carrying out driving based on the drive signal; and the signal output step changes the drive signal based on a moving speed calculated by the calculating step.

A recording medium according to the present invention is a computer readable information storage medium to record a program of the present invention.

### Advantage of the Invention

By an input mechanism according to the present invention, a sense of touch according to an input operation can be provided to a user.

### BRIEF DESCRIPTION OF THE DRAWINGS

FIG. 1A is an example of a structure of an input mechanism in a first exemplary embodiment of the present invention, and indicates an example of a top view.

FIG. 1B is an example of a structure of an input mechanism in the first exemplary embodiment of the present invention, and indicates an example of a sectional view.

FIG. 2A indicates an example of an action of an input mechanism in the first exemplary embodiment of the present invention.

FIG. 2B indicates an example of an action of an input mechanism in the first exemplary embodiment of the present invention.

FIG. 3 indicates an example of an operation flowchart of an input mechanism in the first exemplary embodiment of the present invention.

FIG. 4A is an example of a structure of an input mechanism in a second exemplary embodiment of the present invention, and indicates an example of a top view.

FIG. 4B is an example of a structure of an input mechanism in the second exemplary embodiment of the present invention, and indicates an example of a sectional view.

FIG. 5 indicates an example of a hardware configuration of an input mechanism in the second exemplary embodiment of the present invention.

FIG. 6A indicates an example of an action of an input mechanism in the first exemplary embodiment of the present invention.

FIG. 6B indicates an example of an action of an input mechanism in the first exemplary embodiment of the present invention.

FIG. 7 indicates a diagram which visualizes a difference in moving speeds of a indicating tool using an arrow.

FIG. 8A indicates an example of a voltage signal waveform inputted to a piezoelectric element.

FIG. 8B indicates an example of a voltage signal waveform inputted to a piezoelectric element.

FIG. 9 indicates an example of an operation flowchart of an input mechanism in the second exemplary embodiment of the present invention.

FIG. 10A indicates another example of a structure of an input mechanism in the second exemplary embodiment of the present invention.

FIG. 10B indicates another example of a structure of an input mechanism in the second exemplary embodiment of the present invention.

FIG. 10C indicates another example of a structure of an input mechanism in the second exemplary embodiment of the present invention.

FIG. 10D indicates another example of a structure of an input mechanism in the second exemplary embodiment of the present invention.

FIG. 11A indicates another example of a structure of an input mechanism in the second exemplary embodiment of the present invention.

FIG. 11B indicates another example of a structure of an input mechanism in the second exemplary embodiment of the present invention.

FIG. 12A is an example of a structure of an input mechanism in a third exemplary embodiment of the present invention, and indicates an example of a top view.

FIG. 12B is an example of a structure of an input mechanism in the third exemplary embodiment of the present invention, and indicates an example of a sectional view.

FIG. 13A indicates another example of a structure of an input mechanism in the third exemplary embodiment of the present invention.

FIG. 13B indicates another example of a structure of an input mechanism in the third exemplary embodiment of the present invention.

FIG. 13C indicates another example of a structure of an input mechanism in the third exemplary embodiment of the present invention.

FIG. 13D indicates another example of a structure of an input mechanism in the third exemplary embodiment of the present invention.

FIG. 14A is an example of a structure of an input mechanism in a fourth exemplary embodiment of the present invention, and indicates an example of a top view.

FIG. 14B is an example of a structure of an input mechanism in the fourth exemplary embodiment of the present invention, and indicates an example of a sectional view.

FIG. 15A is an example of a structure of an input device in a fifth exemplary embodiment of the present invention, and indicates an example of a top view.

FIG. 15B is an example of a structure of a input device in the fifth exemplary embodiment of the present invention, and indicates an example of a sectional view.

### DESCRIPTION OF SYMBOLS

10, 10a-10d, 20, 40 and 50 Input mechanism
11 or 32 indicating tool detecting unit
12 and 22 Elastic member
13 and 33 Pressing detection unit
14 and 34 Calculation unit
15 and 39 Driving unit
16 or 37 Signal output unit
21 Photoelectric sensor
23 Piezoelectric element
24 Liquid-proof sheet
25 Supporting member
27 Medium
28 Cover sheet
29 CPU
30 Chassis bottom plate
31 Chassis side plate
35 Determination unit
36 Signal generating unit
38 Recording unit
41a-41d, 42a-42f, 43a-43c, 44a-44d and 45a-45c Individual photoelectric sensor
51 Position sensor
60 Input device

### BEST MODE FOR CARRYING OUT THE INVENTION

### First Exemplary Embodiment

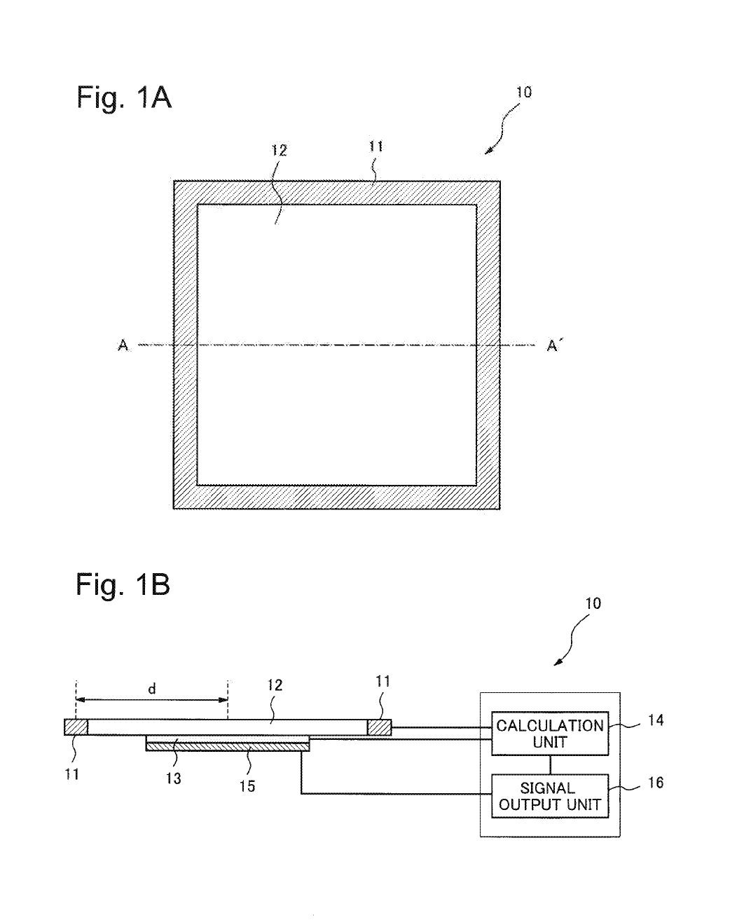

A switch in the first exemplary embodiment of the present invention will be described using FIG. 1A and FIG. 1B. FIG. 1A indicates a top view of an input mechanism 10. FIG. 1B indicates a sectional view of the input mechanism 10 taken in the line A-A′ of FIG. 1A. Meanwhile, a calculation unit 14 and a signal output unit 16 indicate part of a hardware configuration provided in the input mechanism 10.

The input mechanism 10 has an indicating tool detecting unit 11, an elastic member 12, a pressing detection unit 13, the calculation unit 14, a driving unit 15 and the signal output unit 16.

The indicating tool detecting unit 11 is arranged in a predetermined area, and it detects that an indicating tool exists on a predetermined area. Here, an indicating tool indicates something for performing input to the input mechanism 10, such as a user's finger and a stylus pen. The elastic member 12 is arranged in an area at least surrounded by the indicating tool detecting unit 11. The pressing detection unit 13 detects that the elastic member 12 is pressed. The calculation unit 14 calculates a moving speed of an indicating tool from a detection result by the indicating tool detecting unit 11 and a detection result by the pressing detection unit 13. The driving unit 15 applies a force to the elastic member 12 by performing driving based on a drive signal. When the pressing detection unit 13 detects that the elastic member 12 has been pressed, the signal output unit 16 outputs a drive signal to the driving unit 15. According to the moving speed that the calculation unit 14 has calculated, the signal output unit 16 modifies a drive signal to be outputted.

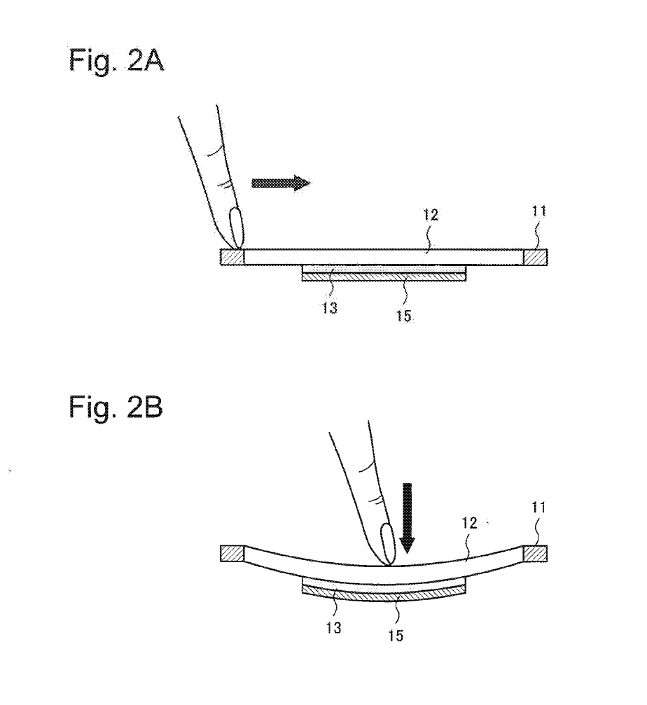

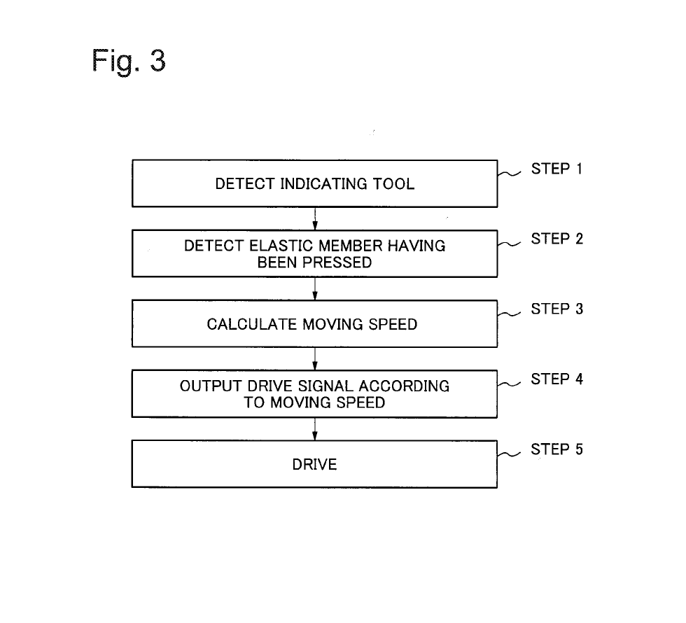

Next, an action of the input mechanism 10 in this exemplary embodiment will be described using FIG. 2A, FIG. 2B and FIG. 3.

Here, it is supposed that an indicating tool is a user's finger, and input is performed to the input mechanism 10 by the user's finger.

When the user's finger exists on the indicating tool detecting unit 11 as shown in FIG. 2A at the beginning, the indicating tool detecting unit 11 detects that the indicating tool exists on the area where the indicating tool detecting unit 11 is arranged (Step 1).

Next, as shown in FIG. 2B, after the user's finger has moved on the elastic member 12, it pushes down near the center of the elastic member 12. At that time, the pressing detection unit 13 detects that the elastic member 12 has been pressed (Step 2).

Then, the calculation unit 14 calculates a moving speed of the user's finger based on a detection result by the indicating tool detecting unit 11 and a detection result by the pressing detection unit 13 (Step 3). Regarding a calculation method of a moving speed, a moving speed is calculated from a distance d between the indicating tool detecting unit 11 and the near center position of the elastic member 12, time at which the indicating tool detecting unit 11 has detected existence of the indicating tool and time at which the pressing detection unit 13 has detected pressing of the elastic member 12, for example.

The signal output unit 16 outputs a drive signal according to the moving speed that the calculation unit 14 has calculated to the driving unit 15 (Step 4).

The driving unit 15 is driven based on the inputted drive signal (Step 5). A force is added to the elastic member 12 by the driving unit 15 being driven, and a sense of touch is provided to the indicating tool.

As above, in this exemplary embodiment, it is possible to provide a sense of touch according to an input operation to a user.

### Second Exemplary Embodiment

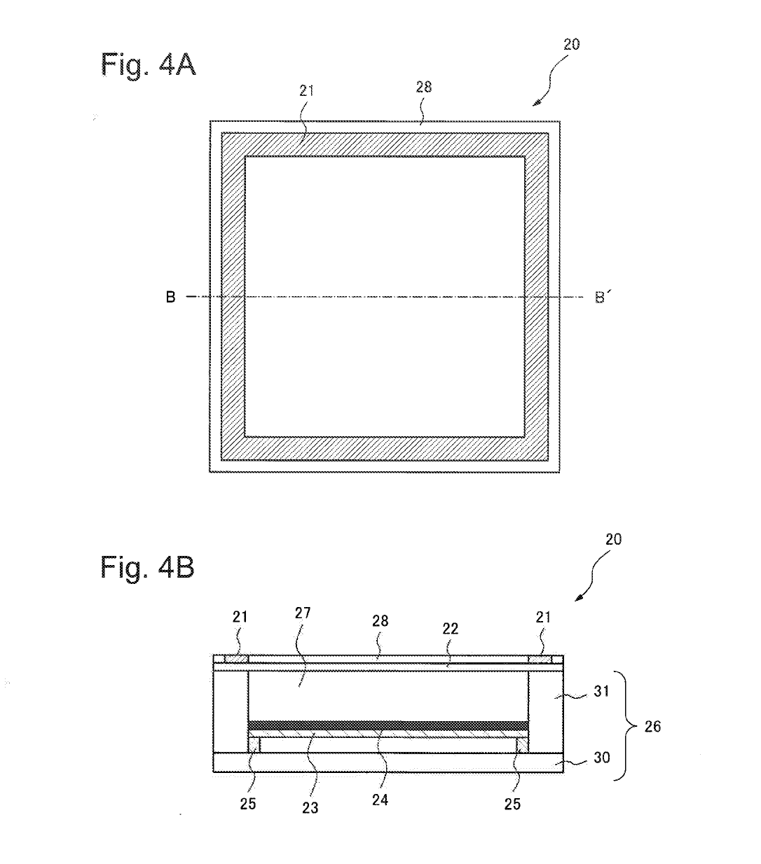

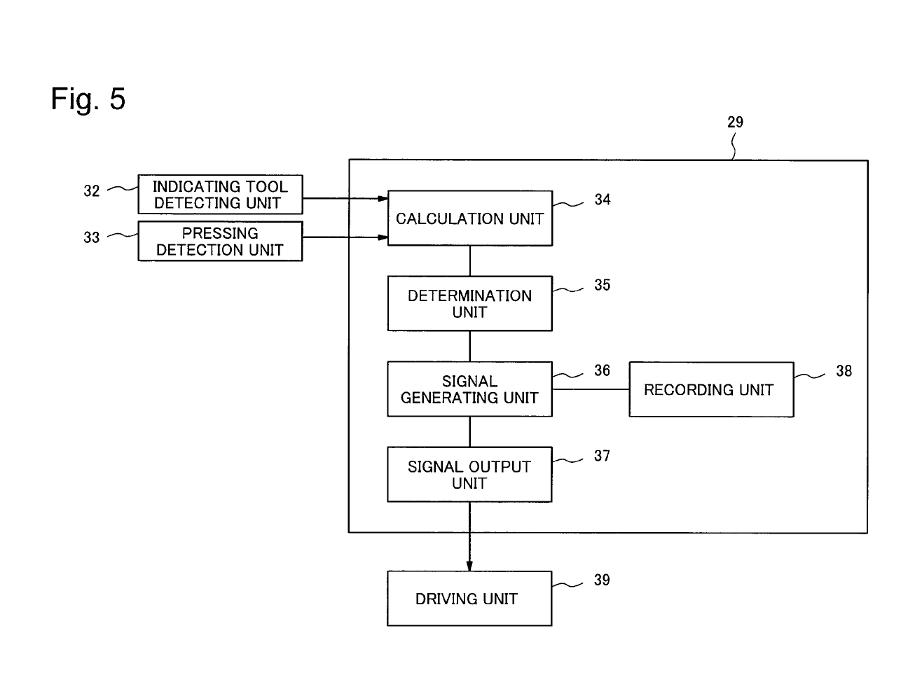

An input mechanism 20 in the second exemplary embodiment of the present invention will be described using FIG. 4A, FIG. 4B and FIG. 5. FIG. 4A indicates a top view of the input mechanism 20. FIG. 4B indicates a sectional view of the input mechanism 20 taken in the line B-B′ of FIG. 4A. FIG. 5 indicates a hardware configuration of the input mechanism 20.

The input mechanism 20 includes a photoelectric sensor 21, an elastic member 22, a piezoelectric element 23, a liquid-proof sheet 24, a supporting member 25, a chassis 26, a medium 27, a cover sheet 28 and a CPU (Central Processing Unit) 29.

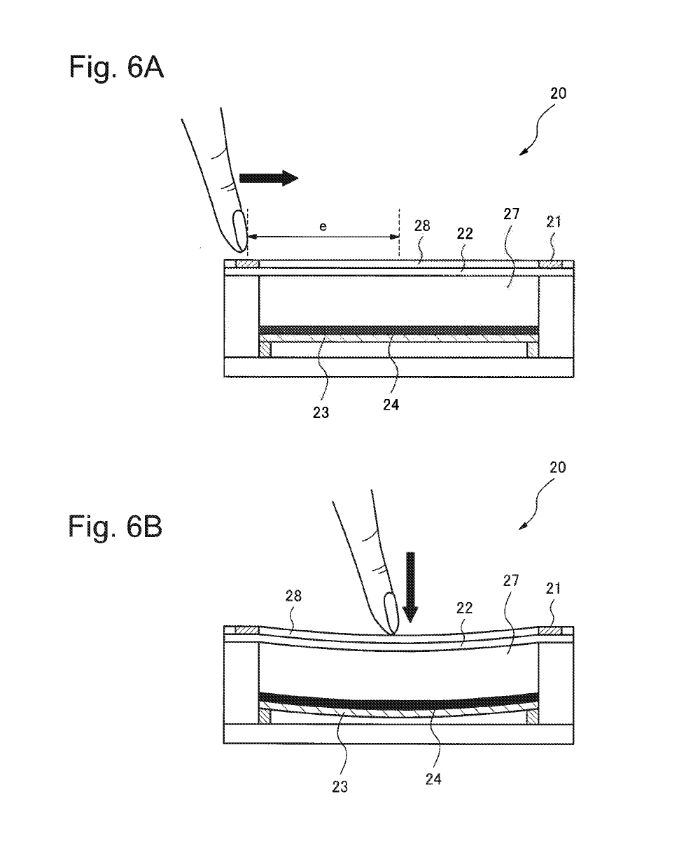

The photoelectric sensor 21 can detect presence or absence of an object on the photoelectric sensor 21. That is, the photoelectric sensor 21 can detect that an indicating tool exists on the photoelectric sensor 21. For example, photoelectric sensor emits a visible ray or an infrared ray as an optical signal, and detects light reflected by a detection object by a light accepting part (in a case of a reflective type) or detects a change in a shaded light quantity by a light accepting part (in a case of a transparent type and a retroreflection type). Therefore, in order for the photoelectric sensor 21 to detect existence of an indicating tool, an indicating tool does not need to touch the photoelectric sensor 21 necessarily. That is, as shown in FIG. 6A, even when a user's finger existing over the photoelectric sensor 21 without touching the photoelectric sensor 21, the photoelectric sensor 21 can detect existence of the user's finger.

The piezoelectric element 23 generates a voltage when deformed by flexion by pressure. The piezoelectric element 23 deforms by flexion by applying a voltage. The liquid-proof sheet 24 prevents the piezoelectric element 23 from touching the medium 27.

The chassis 26 includes a chassis bottom plate 30 and a chassis side plate 31. As a material of the chassis bottom plate 30 and the chassis side plate 31, a metal material such as aluminum and stainless steel and a resin material such as ABS are cited. The chassis side plate 31 is fixed by means of a screw, adhesion or the like on the periphery of the chassis bottom plate 30. An upper surface of the chassis 26 is opened to form an opening area. At least part of the elastic member 22 and the cover sheet 28 is arranged in this opening area.

The piezoelectric element 23 is fixed over the chassis bottom plate 30 sandwiching the supporting member 25, and the liquid-proof sheet 24 is stuck by an adhesive material or the like on the surface of the piezoelectric element 23. Meanwhile, the piezoelectric element 23 in this exemplary embodiment is a bimorph piezoelectric vibrator, for example.

The elastic member 22 is placed on the chassis side plate 31, and the cover sheet 28 and the photoelectric sensor 21 are fixed on it. The photoelectric sensor 21 is located over the chassis side plate 31. Here, it is arranged such that a step is not formed between the photoelectric sensor 21 and the cover sheet 28 by making them be of the same thickness. The photoelectric sensor 21 forms a polygonal peripheral shape as shown in FIG. 4A. The photoelectric sensor 21 in this exemplary embodiment forms a quadrangular peripheral shape. The quadrangular peripheral shape of the photoelectric sensor 21 has a similarity relationship with the outer periphery shape of the upper surface of the chassis 26. The medium 27 is enclosed in the closed space surrounded by the piezoelectric element 23 fixed over the chassis bottom plate 30, the chassis side plate 31 and the elastic member 22. That is, the chassis 26 houses the piezoelectric element 23, the liquid-proof sheet 24, the supporting member 25 and the medium 27 in its interior. The medium 27 arranged underneath the elastic member 22 is a medium by which pressure to the elastic member 22 can be propagated, and is incompressible fluid such as water or the like or gel, for example.

As shown in FIG. 5, a hardware configuration of the input mechanism 20 includes an indicating tool detecting unit 32, a pressing detection unit 33, a calculation unit 34, a determination unit 35, a signal generating unit 36, a signal output unit 37, a recording unit 38 and a driving unit 39. When it is detected that an indicating tool exists over the area where the indicating tool detecting unit 32 is arranged, the indicating tool detecting unit 32 generates an indicating tool detection signal. Here, in this exemplary embodiment, the indicating tool detecting unit 32 is realized by the photoelectric sensor 21. That is, when it is detected that an indicating tool exists over the photoelectric sensor 21, the photoelectric sensor 21 generates an indicating tool detection signal. Similarly, when it is detected that the elastic member 22 that is arranged in the area circled by the photoelectric sensor 21 is pressed by the indicating tool, the pressing detection unit 33 transmits a pressing detection signal. The driving unit 39 drives so that a force may be added to the elastic member 22. Here, in this exemplary embodiment, the pressing detection unit 33 is realized by the piezoelectric element 23. That is, in this exemplary embodiment, when the cover sheet 28 and the elastic member 22 which are arranged in the area surrounded by the photoelectric sensor 21 are pressed by an indicating tool, pressure is propagated via the medium 27, and the piezoelectric element 23 is flexion-deformed, forming convexity toward the downward direction. At that time, by a piezoelectric effect, a voltage signal as a pressing detection signal occurs to a first terminal (not shown) provided in the piezoelectric element 23. In this way, the piezoelectric element 23 functions as the pressing detection unit 33 by detecting that the elastic member 22 is pressed and generating a voltage signal.

The CPU 29 performs a series of processing of calculating a moving speed of the indicating tool, determining whether the calculated moving speed exceeds a predetermined threshold value or not, and generating and outputting a drive signal. Specifically, the calculation unit 34 calculates a moving speed of the indicating tool from time when a indicating tool detection signal is generated in the photoelectric sensor 21 and time when a voltage signal is generated in the piezoelectric element 23. Then, the determination unit 35 determines whether the moving speed of the indicating tool calculated by the calculation unit 34 is larger than a predetermined threshold value or not. Meanwhile, it may be arranged such that a user can set a predetermined threshold value of a moving speed freely in advance.

Here, in the recording unit 38, a drive signal waveform according to the magnitude of a moving speed of an indicating tool has been recorded. That is, two different drive signals correlated to whether a moving speed exceeds a predetermined threshold value or not have been recorded. In other words, as two different drive signals, for example, a drive signal which is correlated to a case when a moving speed of an indicating tool exceeds a predetermined threshold value, and a drive signal which is correlated to a case when a moving speed of an indicating tool does not exceed the predetermined threshold value, have been recorded in the recording unit 38. The signal generating unit 36 reads a drive signal waveform recorded in the recording unit 38 according to a determination result of the determination unit 35, and generates a drive signal. That is, the signal generating unit 36 reads either one of the two drive signals from the recording unit 38 according to the determination result of the determination unit 35, and generates it as a drive signal. Then, the signal output unit 37 outputs the drive signal generated by the signal generating unit 36 to the driving unit 39. The driving unit 39 performs driving by being inputted a drive signal. Meanwhile, in this exemplary embodiment, the driving unit 39 is realized by the piezoelectric element 23. A drive signal which the signal generating unit 36 generates is a voltage signal to be inputted to the piezoelectric element 23. That is, when a voltage signal is inputted to a second terminal (not shown) provided in the piezoelectric element 23, the piezoelectric element 23 is transformed forming convexity in the upward direction or downward direction. Therefore, pressure applied to the medium 27 changes, the elastic member 22 and the cover sheet 28 are transformed in a manner forming convexity in the upward direction or downward direction. As a result, a sense of touch is provided to the indicating tool on the cover sheet 28. In this way, the piezoelectric element 23 functions as the driving unit 39. That is, in this exemplary embodiment, the piezoelectric element 23 also functions as the driving unit 39 while functioning as the pressing detection unit 33.

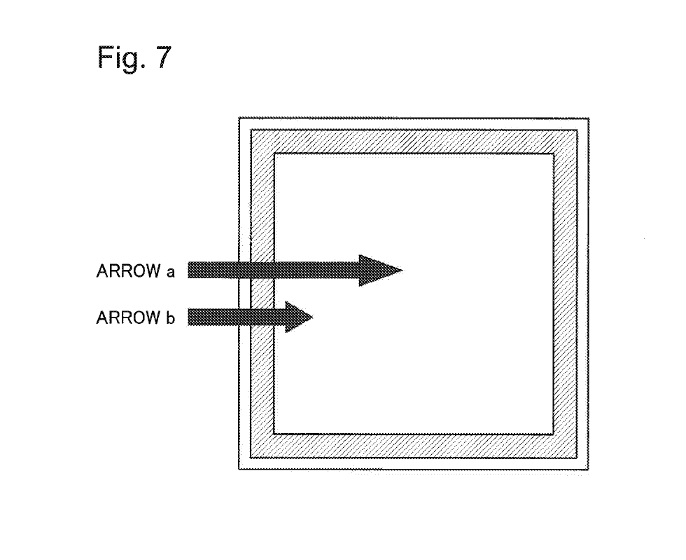

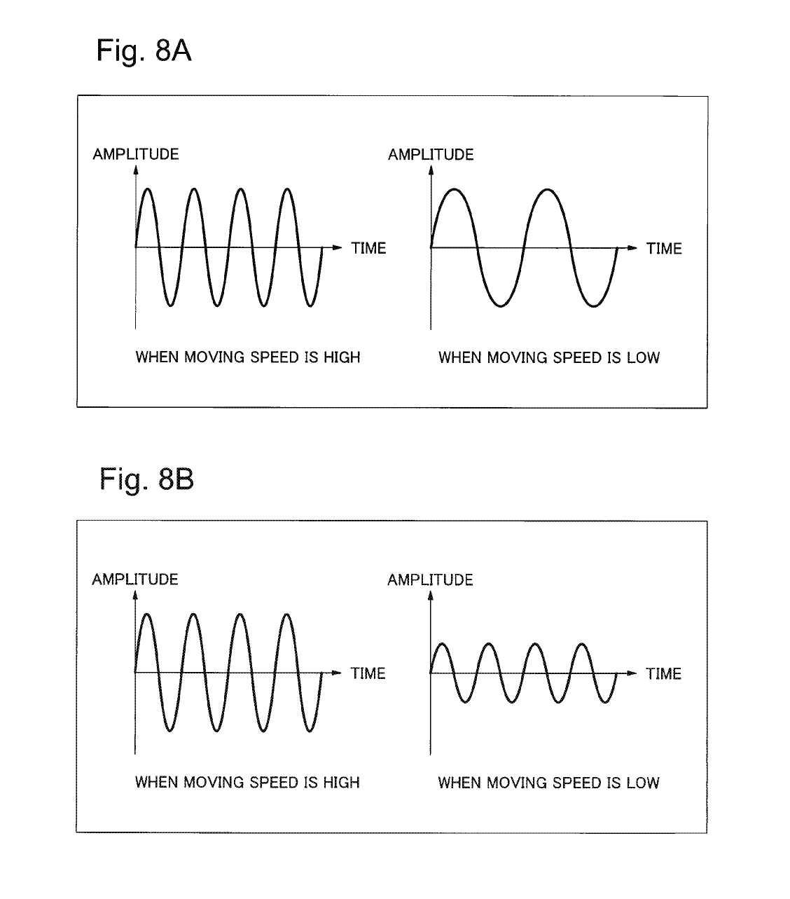

Next, an action of the input mechanism 20 will be described in detail using FIGS. 6A to 9. FIG. 6A and FIG. 6B indicate a sectional view of the input mechanism 20 in a case of performing input by an indicating tool. FIG. 7 is a diagram which visualizes a difference in moving speeds of the indicating tool using an arrow. Here, it shows that the longer an arrow is, the larger a moving speed is. That is, the arrow a shown in FIG. 7 shows the state that the moving speed is large compared with that of the arrow b. FIG. 8A and FIG. 8B indicate examples of a voltage signal waveform to be applied to the piezoelectric element 23. FIG. 8A shows a case in which control is performed so that, when a moving speed of an indicating tool is large (the arrow a of FIG. 7), a frequency of an applied voltage signal may become high compared with a case where a moving speed of the indicating tool is small (the arrow b of FIG. 7). FIG. 8B shows a case in which control is performed so that, when a moving speed of an indicating tool is large (the arrow a of FIG. 7), amplitude of a voltage signal may become large compared with a case where a moving speed of an indicating tool is small (the arrow b of FIG. 7).

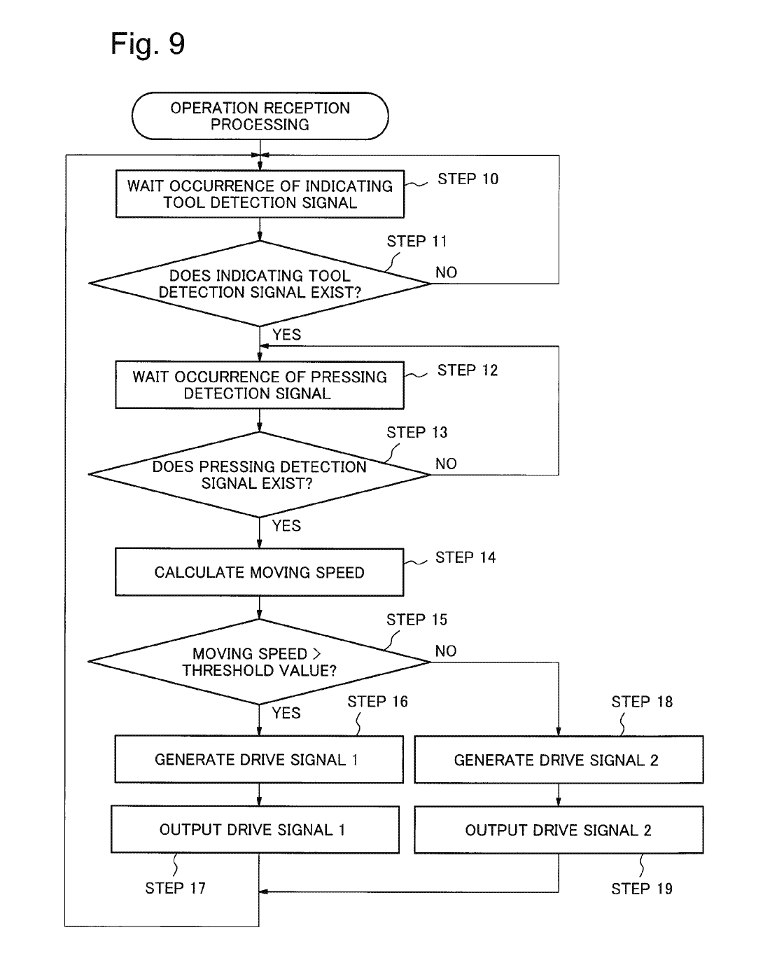

FIG. 9 is an operation flowchart of the input mechanism 20. First, when the input mechanism 20 starts, operation reception processing is carried out. Then, the input mechanism 20 will be in a waiting state of occurrence of an indicating tool detection signal from the photoelectric sensor 21 as the indicating tool detecting unit 32 (Step 10). The input mechanism 20 determines presence or absence of an indicating tool detection signal from the photoelectric sensor 21 (Step 11). Here, as shown in FIG. 6A, when an indicating tool passes over the photoelectric sensor 21, an indicating tool detection signal which shows that an indicating tool exists is transmitted from the photoelectric sensor 21 (in Step 11, YES). In this case, the input mechanism 20 will be in an occurrence waiting state of a pressing detection signal from the pressing detection unit 33 (Step 12). Meanwhile, in this exemplary embodiment, the pressing detection unit 33 is realized by the piezoelectric element 23.

A pressing detection signal is a voltage signal which occurs from the piezoelectric element 23. On the other hand, when an indicating tool detection signal is not transmitted from the photoelectric sensor 21 (in Step 11, NO), the input mechanism 20 returns to the occurrence waiting state of an indicating tool detection signal (Step 10).

Then, the indicating tool slides on the cover sheet 28 and pushes down around the center of the area surrounded by the photoelectric sensor 21. At that time, the cover sheet 28 and the elastic member 22 transforms in a manner forming convexity in the downward direction, and pressure by pressing by the indicating tool is propagated through the medium 27, resulting in transformation of the piezoelectric element 23 as shown in FIG. 6B. As a result, a voltage signal as a pressing detection signal occurs between first terminals (not shown) provided in the piezoelectric element 23 (in Step 13, YES). At that time, the piezoelectric element 23 is functioning as the pressing detection unit 33.

Next, the calculation unit 34 calculates the moving speed of the indicating tool based on the time when the indicating tool detection signal has occurred from the photoelectric sensor 21 and the time when the voltage signal has occurred from the piezoelectric element 23 (Step 14). Specifically, the calculation unit 34 has recorded a distance e between the photoelectric sensor 21 and a position near the center of the elastic member 22, in advance. The calculation unit 34 calculates a time difference between the time when the indicating tool detection signal has been generated and the time when the pressing detection signal has been generated. Then, the calculation unit 34 calculates a moving speed of the indicating tool from the time difference and the distance e recorded in advance. Meanwhile, it may be arranged such that information on the distance e is recorded in the recording unit 38, and the calculation unit 34 reads the information on the distance e from the recording unit 38.

Here, there is a case where a moving distance of an indicating tool is not necessarily the distance e, causing some difference. In other words, depending on which position of the elastic member 22 is pressed by an indicating tool after it having passed which position over the photoelectric sensor 21, a moving distance of the indicating tool fluctuates. Therefore, in order to calculate a moving speed correctly, it is necessary to calculate a moving distance of a indicating tool correctly by such as installing a position sensor separately. However, in this exemplary embodiment, a moving speed that the calculation unit 34 calculates does not need to be correct necessarily, and it should be simply such that a moving speed can be classified roughly in Step 15 mentioned later. In general, when pressing is made by an indicating tool, the center of the pressing allowed area (in this exemplary embodiment, the center of the area circled by the photoelectric sensor 21) is often pressed. Therefore, it is inconceivable that a substantial difference occurs between an actual moving distance and the distance e. From the above reason, even if a position sensor is not added newly, it is possible to provide a sense of touch according to a moving speed. However, when there is a need to calculate a moving speed more correctly, a position sensor may be installed as is the case with the fourth exemplary embodiment mentioned later.

The determination unit 35 determines whether the moving speed that the calculation unit 34 has calculated is larger than a predetermined threshold value (Step 15). When the moving speed of the indicating tool is larger than the predetermined threshold value (in Step 15, YES), a drive signal 1 is generated (Step 16), and the drive signal 1 is outputted to the driving unit 39 (Step 17). Then, the processing returns to the occurrence waiting state of an indicating tool detection signal (Step 10). On the other hand, when the moving speed of the indicating tool is equal to or less than the predetermined threshold value (in Step 15, NO), a drive signal 2 different from the drive signal 1 is generated (Step 18), and the drive signal 2 is outputted to the driving unit 39 (Step 19). Then, the input mechanism 20 returns to the occurrence waiting state of an indicating tool detection signal (Step 10). Meanwhile, the driving unit 39 in this exemplary embodiment is realized by the piezoelectric element 23. A drive signal inputted to the piezoelectric element 23 is a voltage signal. Here, it is supposed that the drive signal 1 is a voltage signal 1, and the drive signal 2 is a voltage signal 2. The voltage signal 1 and the voltage signal 2 are voltage signals having frequencies and amplitude different from each other as shown in FIG. 8A and FIG. 8B, for example. For example, the voltage signal 1 and the voltage signal 2 are set to two kinds of signal waveforms as shown in FIG. 8A, respectively. In this case, when a moving speed of the indicating tool is larger than a predetermined threshold value, a voltage signal having a frequency larger than that of a case where the moving speed is equal to or less than the predetermined threshold value is outputted. Therefore, according to a difference in moving speeds, that is, a difference in input operations, a different sense of touch is provided to the user. As shown in FIG. 8B, the voltage signal 1 and the voltage signal 2 may be of signal waveforms having amplitude different from each other. In this case, when a moving speed of an indicating tool is larger than a threshold value, a voltage signal having amplitude larger than that of a case where the moving speed is equal to or less than the threshold value is outputted. Therefore, a different sense of touch is provided to a user also in this case according to a difference in moving speeds, that is, a difference in input operations. Meanwhile, in FIG. 8A, FIG. 8B and Steps 15-19 of FIG. 9, although moving speeds of an indicating tool are classified into two by one threshold value, it is not limited to this. That is, it may be such that no smaller than two threshold values for a moving speed are set up, and voltage signals of the larger number of patterns are correlated to them. Meanwhile, it may be such that magnitude and the number of threshold values can be changed according to need.

In this way, the input mechanism 20 in this exemplary embodiment changes a voltage signal to be inputted to the piezoelectric element 23 according to a moving speed of an indicating tool, and feeds back senses of touch different from each other to the indicating tool via the cover sheet 28. Therefore, a sense of touch according to an input operation can be provided to a user.

Moreover, in this exemplary embodiment, the photoelectric sensor 21 and the cover sheet 28 are made be of the same thickness, and a step is not caused between both of them. Therefore, when an indicating tool slides on the photoelectric sensor 21 and the cover sheet 28, an unpleasant sense of touch by a step does not occur.

Further, in this exemplary embodiment, although it has been supposed that the chassis bottom plate 30 and the chassis side plate 31 are formed by separate components, they may be formed by a one-piece component.

Also, in this exemplary embodiment, although it has been supposed that the cover sheet 28 is placed on the elastic member 22, it may be such that the elastic member 22 and the cover sheet 28 are composed by a one-piece part. It may be also such that the elastic coefficients of the elastic member 22 and the cover sheet 28 are the same, or different from each other.

Further, in FIG. 5, although the recording unit 38 is provided inside the CPU 29, it is not limited to this. That is, the recording unit 38 may be provided outside the CPU 29. Moreover, in FIG. 5, although the signal generating unit 36 and the signal output unit 37 have been described separately, they may be realized by one part.

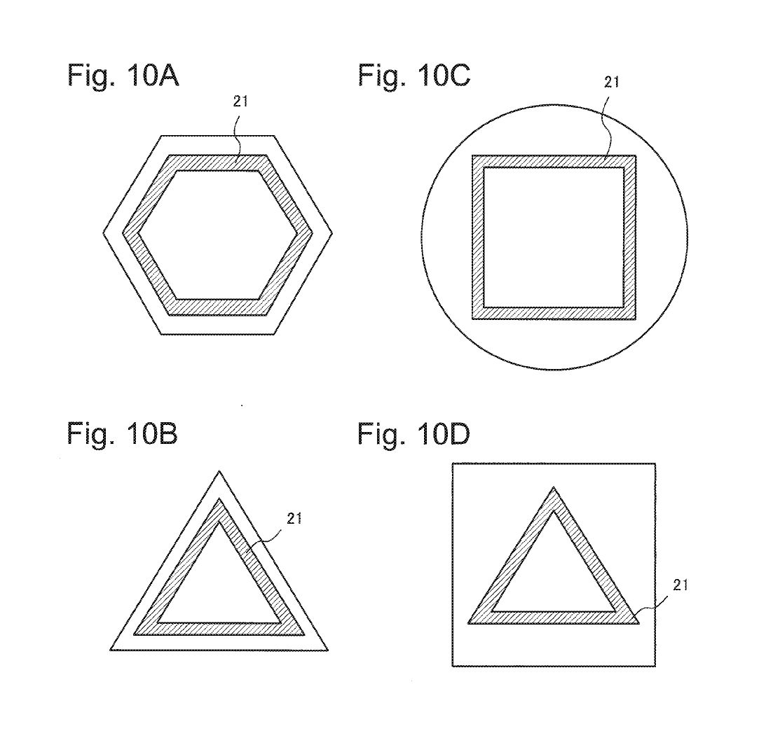

Yet further, although it has been supposed that the photoelectric sensor 21 in this exemplary embodiment forms a quadrangular peripheral shape, it is not limited to this. For example, as shown in FIG. 10A and FIG. 10B, a hexagonal and a triangle peripheral shape may be formed. In this exemplary embodiment, although it has been supposed that a peripheral shape formed by the photoelectric sensor 21 is in a similarity relationship with an outer periphery shape of the upper surface of the chassis 26, it is not limited to this. For example, as shown in FIG. 10C and FIG. 10D, there may be no similarity relationship between a peripheral shape formed by the photoelectric sensor 21 and an outer periphery shape of the upper surface of the chassis 26.

Meanwhile, in this exemplary embodiment, although calculation of a moving speed by the calculation unit 34 begins when a voltage signal is generated from the piezoelectric element 23, it is not limited to this. For example, it may be such that, only when the magnitude of a voltage signal which occurs from the piezoelectric element 23 exceeds a predetermined threshold value, calculation of a moving speed by the calculation unit 34 and input of a voltage signal to the piezoelectric element 23 may be carried out. In this case, it may be such that the calculation unit 34 determines whether the magnitude of a voltage signal outputted from the piezoelectric element 23 exceeds a predetermined threshold value or not. Or, a determination unit which determines whether the magnitude of a voltage signal outputted from the piezoelectric element 23 exceeds a predetermined threshold value or not may be installed apart from the calculation unit 34. As a result, when a user cancels input to the input mechanism 20 on the way, and the magnitude of a voltage signal which occurs from the piezoelectric element 23 is not enough, processing of Steps 14-19 in FIG. 9 is not carried out. Therefore, misunderstanding that input has been completed caused by a sense of touch that has been provided in spite of a user having canceled input to the input mechanism 20 on the way can be prevented.

Meanwhile, in this exemplary embodiment, although it has been supposed that the indicating tool detecting unit 32 is realized by the photoelectric sensor 21, it is not limited to this. For example, as the indicating tool detecting unit 32, another sensor such as an electrostatic sensor which detects touch by an indicating tool may be used.

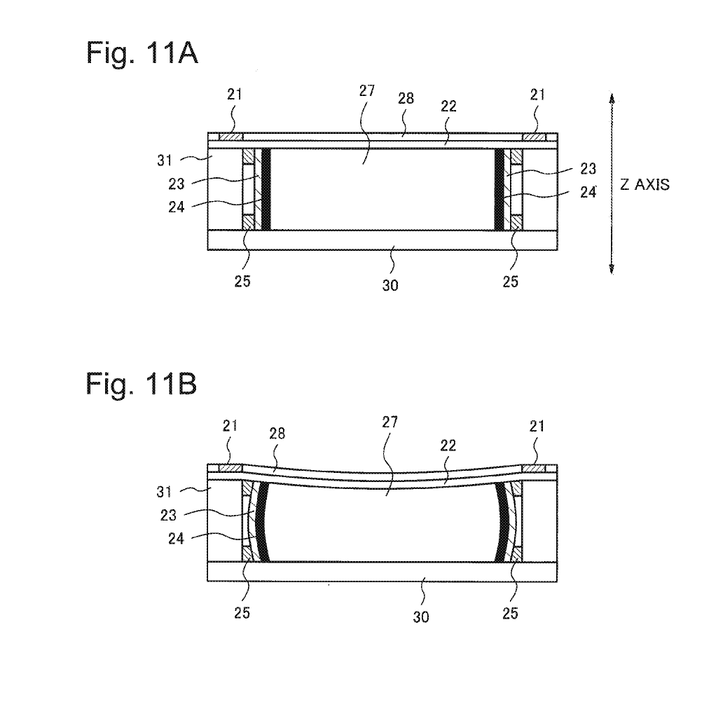

In this exemplary embodiment, although it is arranged such that the piezoelectric element 23 is fixed over the chassis bottom plate 30 in a manner sandwiching the supporting member 25, it is not limited to this. For example, as shown in FIG. 11A, it may be such that it is fixed to the chassis side plate 31 sandwiching the supporting member 25. In this case, when the elastic member 22 is pressed by an indicating tool, the piezoelectric element 23 deforms by flexion as shown in FIG. 11B. That is, the piezoelectric element 23 may be formed parallel to the elastic member 22, or may be formed vertically to the elastic member 22. In this regard, however, in the case where the piezoelectric element 23 is formed parallel to the elastic member 22 as is the case with this exemplary embodiment, an input mechanism can be made thinner than the case formed vertically to the elastic member 22. This is because, even if the length of an input mechanism in the Z axis direction is made small, it is possible to secure a contact area of the piezoelectric element 23 and the medium 27 (in this exemplary embodiment, the contact area via the liquid-proof sheet 24) sufficiently.

### Third Exemplary Embodiment

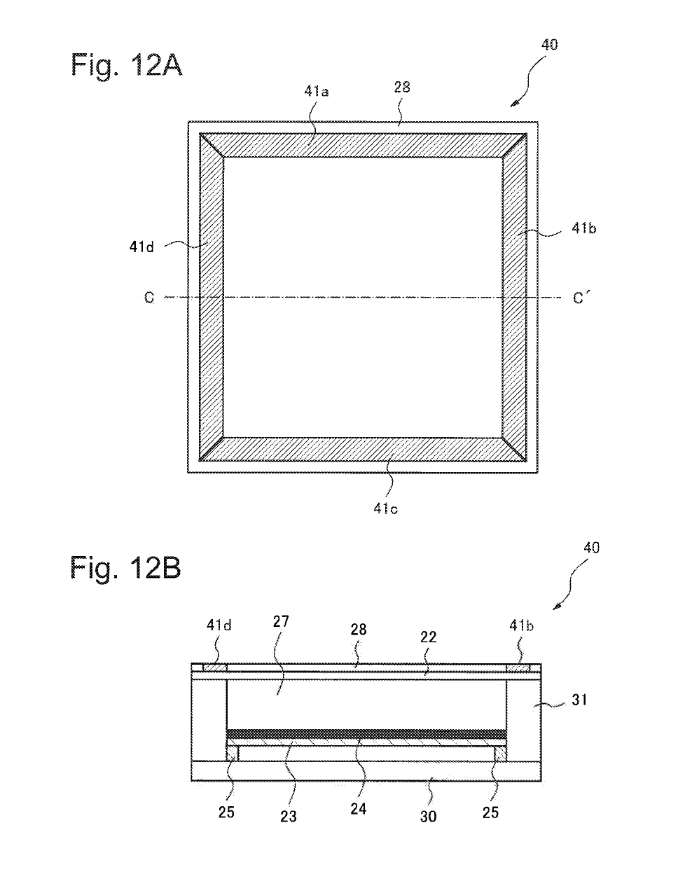

An input mechanism 40 in the third exemplary embodiment of the present invention will be described using FIG. 12A and FIG. 12B. FIG. 12A indicates a top view of the input mechanism 40 in this exemplary embodiment. FIG. 12B indicates a sectional view of the input mechanism 40 taken in the line C-C′ of FIG. 12A.

The input mechanism 40 has a different structure of a photoelectric sensor compared with the input mechanism 20 of the second exemplary embodiment. That is, in the input mechanism 40, a plurality of individual photoelectric sensors 41a-41d are provided unlike the input mechanism 20. Each of the plurality of individual photoelectric sensors 41a-41d forms a shape of a side of a quadrangle, and, in this exemplary embodiment, a shape of a side of a polygon. Pieces of identification information different from each other are assigned to the plurality of individual photoelectric sensors 41a-41d, respectively. Meanwhile, description will be omitted about structures of the input mechanism 40 that are the same as those of the input mechanism 20.

Next, action of the input mechanism 40 will be described. Meanwhile, because the outline of the hardware configuration of the input mechanism 40 is similar to the hardware configuration of the input mechanism 20 shown in FIG. 5, it will be described also referring to FIG. 5.

First, it is supposed that an indicating tool has passed over the individual photoelectric sensor 41b among the individual photoelectric sensors 41a-41d. In this case, the individual photoelectric sensor 41b transmits an indicating tool detection signal and transmits identification information assigned to the individual photoelectric sensor 41b.

Next, when the cover sheet 28 and the elastic member 22 which are arranged in the area circled by the individual photoelectric sensors 41a-41d are pressed by the indicating tool, the piezoelectric element 23 is deformed by flexion, and generates a voltage signal.

When a voltage signal occurs from the piezoelectric element 23, the calculation unit 34 calculates a moving speed of the indicating tool. Then, the determination unit 35 determines whether the calculated moving speed exceeds a predetermined threshold value.

Here, drive signal waveforms corresponding to magnitude of a moving speed and identification information on an individual photoelectric sensor are recorded in the recording unit 38 provided in the input mechanism 40. That is, different drive signal waveforms have been set according to which of the individual photoelectric sensors 41a-41d is an individual photoelectric sensor over which an indicating tool passes.

The signal generating unit 36 reads a drive signal waveform corresponding to a determination result by the determination unit 35 and the identification information on the individual photoelectric sensor 41b from the recording unit 38. After that, the signal output unit 37 outputs a drive signal which the signal generating unit 36 has generated to the piezoelectric element 23 that is the driving unit 39.

Thus, in this exemplary embodiment, it can be distinguished over which of the individual photoelectric sensors 41a-41d an indicating tool has passed. Senses of touch different from each other can be presented to a user according to not only a difference in moving speeds of an indicating tool but also over which of the individual photoelectric sensors 41a-41d the indicating tool has passed. Therefore, it can classify input operations more in detail and present a sense of touch according to respective input operations to a user.

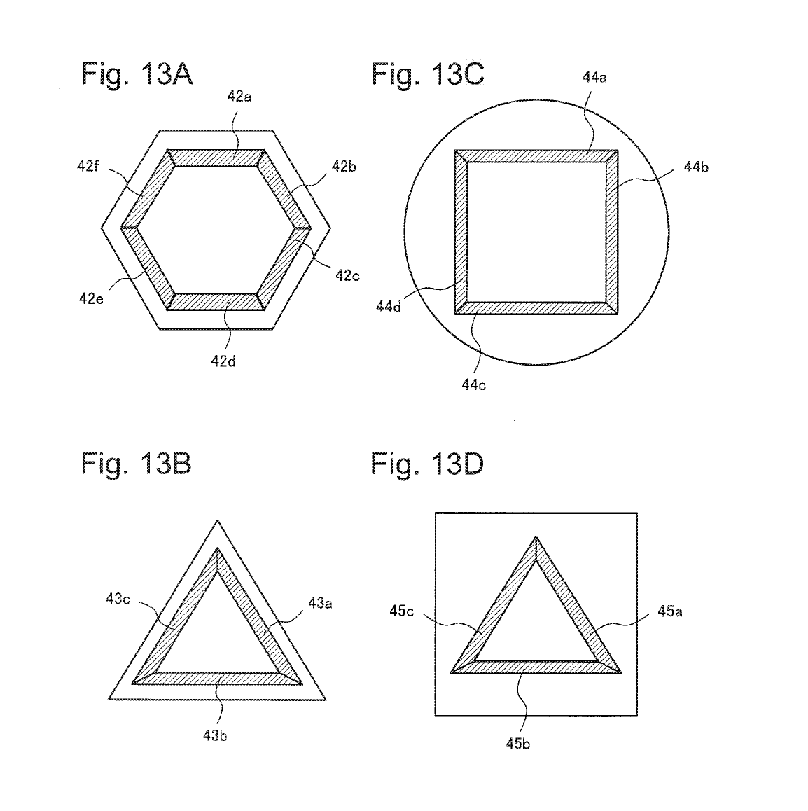

Meanwhile, in this exemplary embodiment, although it is supposed that a plurality of individual photoelectric sensors form a shape of a side of a quadrangle respectively, it is not limited to this. For example, as shown in FIG. 13A and FIG. 13B, a plurality of individual photoelectric sensors 42a-42f and 43a-43c may form a shape of a side of a hexagon and a triangle, respectively. Further, as shown in FIG. 13C and FIG. 13D, there may be no similarity relationship between polygonal peripheral shapes formed by a plurality of individual photoelectric sensors 44a-44d and 45a-45c and the outer periphery shape of the upper surface of the chassis 26.

### Fourth Exemplary Embodiment

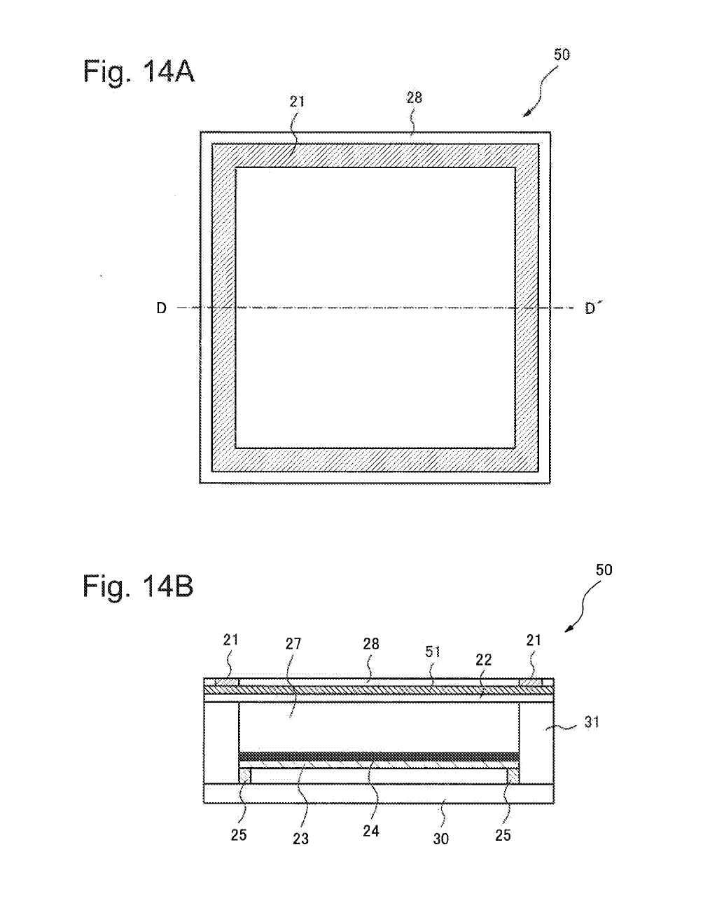

An input mechanism 50 in the fourth exemplary embodiment of the present invention will be described using FIG. 14A and FIG. 14B. FIG. 14A indicates a top view of the input mechanism 50 in this exemplary embodiment. FIG. 14B indicates a sectional view of the input mechanism 50 taken in the line D-D′ of FIG. 14A.

The input mechanism 50 in this exemplary embodiment is of a structure in which a position sensor 51 is added to the input mechanism 20 of the second exemplary embodiment. When an indicating tool exists on the photoelectric sensor 21, the position sensor 51 detects in which position of the photoelectric sensor 21 it exists. Moreover, at a time when the piezoelectric element 23 generates a voltage signal, the position sensor 51 detects a position where the maximum pressing force is applied. That is, the position sensor 51 detects the position where the indicating tool presses the elastic member 22. For example, the position sensor 51 is inserted between the cover sheet 28 and the elastic member 22.

The calculation unit 34 calculates a moving speed of the indicating tool using location information which the position sensor 51 has detected. That is, the calculation unit 34 calculates a moving distance of the indicating tool from the location information which shows on which position of the photoelectric sensor 21 the indicating tool has existed and the location information which shows which position of the elastic member 22 the indicating tool has pressed. A moving speed of the indicating tool is calculated from the moving distance, the time when an indicating tool detection signal has been generated and the time when a pressing detection signal has been generated. Therefore, the calculation unit 34 in this exemplary embodiment does not need to record information on the distance e in the second exemplary embodiment. Description will be omitted about other actions because they are the same as those of the second exemplary embodiment.

As above, in this exemplary embodiment, a distance between a position at which an indicating tool has passed the photoelectric sensor 21 and a position at which the elastic member 22 is pressed can be calculated based on location information which has been detected by the position sensor 51. Therefore, a moving speed of an indicating tool can be calculated more correctly compared with the second exemplary embodiment.

Meanwhile, in this exemplary embodiment, although it is arranged such that the position sensor 51 is provided apart from the photoelectric sensor 21, it is not limited to this. For example, it may be such that the position sensor 51 is made to have the function as the indicating tool detecting unit to detect touching of an indicating tool. That is, it may be such that detection of contact of an indicating tool and detection of location information is carried out by one part.

### Fifth Exemplary Embodiment

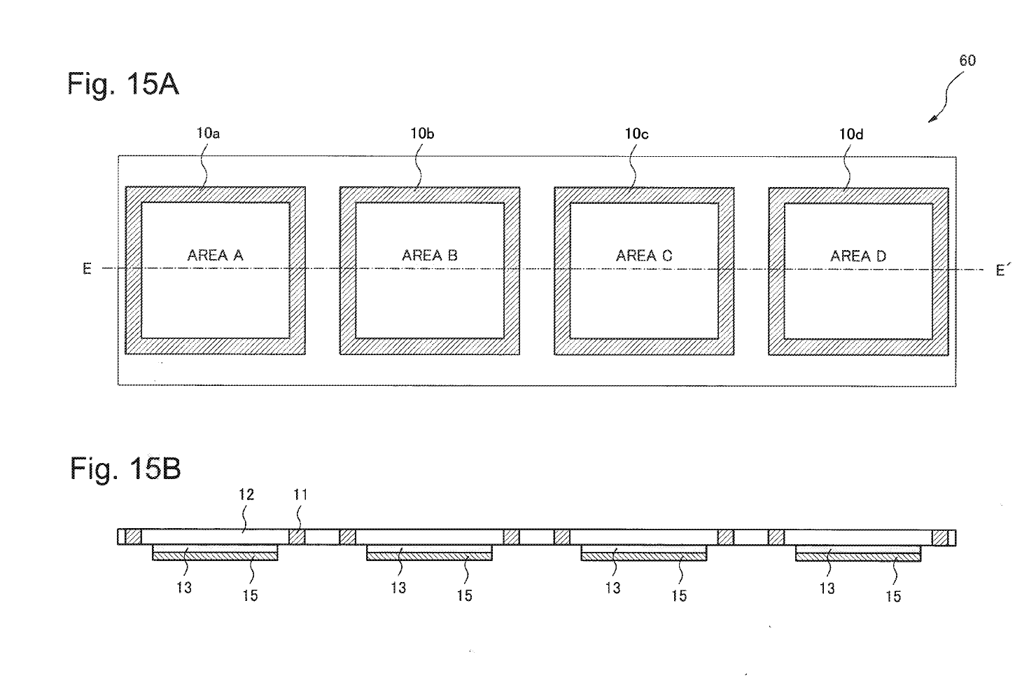

An input device 60 in the fifth exemplary embodiment of the present invention will be described using FIG. 15A and FIG. 15B. FIG. 15A is a top view of the input unit 60. FIG. 15B is a sectional view taken in the line E-E′ of FIG. 15A. As shown in FIG. 15A and FIG. 15B, the input device 60 in this exemplary embodiment is of a structure including a plurality of pieces of input mechanism 10 in the first exemplary embodiment (input mechanisms 10a-10d). Here, it is supposed that areas circled by the indicating tool detecting unit 11 in each of the input mechanisms 10a-10d are areas A-D. Input information inputted to the input device 60 may be changed according to which area of the elastic member 12 among the areas A-D has been pressed.

Further, although it has been supposed that the input device 60 in this exemplary embodiment is of a structure having a plurality of input mechanism 10, it is not limited to this. For example, it may be of a structure having a plurality of input mechanisms 20, 40 or 50 in the second to fourth exemplary embodiments.

Although the exemplary embodiments according to the present invention has been described with reference to a drawing above, it goes without saying that the present invention is not limited to the exemplary embodiments. The shapes of each constructional element and their combinations and the like indicated in the exemplary embodiments mentioned above are just examples, and various modifications are possible based on a design request and the like within a range that does not deviate from the main purpose of the present invention.

Part or all of the above-mentioned exemplary embodiments can also be described as, but not limited to, the following supplementary notes.

(Supplementary note 1) An input mechanism, comprising: an indicating tool detecting unit, arranged in a predetermined area, to detect existence of an indicating tool on the predetermined area;

an elastic member arranged in an area circled by the indicating tool detecting unit;

a pressing detection unit to detect the elastic member having being pressed;

a calculation unit to calculate a moving speed of the indicating tool from a detection result by the indicating tool detecting unit and a detection result by the pressing detection unit;

a signal output unit to output a drive signal, upon the pressing detection unit detecting the elastic member having been pressed; and

a driving unit to apply a force to the elastic member by carrying out driving based on the drive signal; wherein

the signal output unit changes the drive signal to be outputted based on a moving speed calculated by the calculation unit.

(Supplementary note 2) The input mechanism according to supplementary note 1, wherein the indicating tool detecting unit comprises a plurality of individual indicating tool detecting units, to the individual indicating tool detecting units identification information different from each other being assigned, respectively, and wherein
the signal output unit changes the drive signal based on the moving speed and identification information on an individual indicating tool detecting unit having detected existence of the indicating tool.

(Supplementary note 3) The input mechanism according to supplementary note 2, wherein the indicating tool detecting unit forms a peripheral shape of a polygon, and wherein the plurality of individual indicating tool detecting units form a shape of a side of the polygon, respectively.

(Supplementary note 4) The input mechanism according to any one of Supplementary notes 1 to 3, further comprising: a medium, arranged underneath the elastic member, capable of propagating a pressure applied to the elastic member; and

a chassis to store the medium, the pressing detection unit and the driving unit in its interior; wherein

the pressing detection unit detects the elastic member having been pressed via the medium.

(Supplementary note 5) The input mechanism according to supplementary note 4, wherein the chassis has an opening area in an upper surface, wherein

at least part of the elastic member is arranged in the opening area, and wherein

a shape formed by the indicating tool detecting unit has a similarity relationship with an outer periphery shape of the upper surface of the chassis.

(Supplementary note 6) The input mechanism according to any one of supplementary notes 1 to 5, comprising: a piezoelectric element, the piezoelectric element being the pressing detection unit and also being the driving unit;

upon the elastic member being pressed, the piezoelectric element being deformed by flexion and generating a voltage signal; and the drive signal being a voltage signal.

(Supplementary note 7) The input mechanism according to supplementary note 6, wherein the signal output unit outputs the voltage signal to the piezoelectric element, only upon magnitude of a voltage signal occurring from the piezoelectric element exceeding a predetermined threshold value.

(Supplementary note 8) The input mechanism according to supplementary notes 6 or 7, wherein the signal output unit changes, according to a moving speed calculated by the calculation unit, at least one of amplitude and a frequency of a voltage signal outputted to the piezoelectric element.

(Supplementary note 9) The input mechanism according to any one of supplementary notes 1 to 8, wherein the piezoelectric element is a bimorph type piezoelectric element.

(Supplementary note 10) The input mechanism according to any one of supplementary notes 1 to 9, wherein the indicating tool detecting unit is a photoelectric sensor.

(Supplementary note 11) The input mechanism according to any one of supplementary notes 1 to 10, wherein the indicating tool detecting unit further comprises a position sensor to acquire location information of the indicating tool upon detecting existence of the indicating tool, and location information of the indicating tool upon the pressing detection unit detecting the elastic member having been pressed.

(Supplementary note 12) An input device comprising a plurality of input mechanisms according to any one of supplementary notes 1 to 11.

(Supplementary note 13) An input mechanism control method, comprising: an indicating tool detection step of detecting an indicating tool existing on a predetermined area;

a pressing detection step of detecting an elastic member, arranged in an area circled by the predetermined area, having been pressed;

a calculating step of calculating a moving speed of the indicating tool from a detection result by the indicating tool detection step and a detection result by the pressing detection step;

a signal output step of outputting a drive signal, upon detecting the elastic member having been pressed by the pressing detection step; and

a driving step of applying a force to the elastic member by carrying out driving based on the drive signal; wherein

the signal output step changes the drive signal based on a moving speed calculated by the calculating step.

(Supplementary note 14) A program for making a computer carry out: an indicating tool detection step of detecting an indicating tool existing on a predetermined area;

a pressing detection step of detecting an elastic member, arranged in an area circled by the predetermined area, having been pressed;

a calculating step of calculating a moving speed of the indicating tool from a detection result by the indicating tool detection step and a detection result by the pressing detection step;

a signal output step of outputting a drive signal, upon detecting the elastic member having been pressed by the pressing detection step; and

a driving step of applying a force to the elastic member by carrying out driving based on the drive signal; wherein

the signal output step changes the drive signal based on a moving speed calculated by the calculating step.

(Supplementary note 15) A computer readable information storage medium to record a program according to supplementary note 14.

This application claims priority based on Japanese application Japanese Patent Application No. 2011-043743, filed on Mar. 1, 2011, the disclosure of which is incorporated herein in its entirety.

### INDUSTRIAL APPLICABILITY

An input mechanism of the present invention can be applied to various input mechanisms of such as a information terminal, a digitizing tablet and a tactile display such as virtual reality.

What is claimed is:

1. An input mechanism, comprising:
an indicating tool detecting unit, arranged in a predetermined area, to detect existence of an indicating tool on said predetermined area;
an elastic member arranged in an area circled by said indicating tool detecting unit;
a pressing detection unit to detect said elastic member having been pressed;
a calculation unit to calculate a moving speed of said indicating tool from a detection result by said indicating tool detecting unit and a detection result by said pressing detection unit;
a signal output unit to output a drive signal, upon said pressing detection unit detecting said elastic member having been pressed; and
a driving unit to apply a force to said elastic member by carrying out driving based on said drive signal; wherein
said signal output unit changes said drive signal to be outputted based on a moving speed calculated by said calculation unit.

2. The input mechanism according to claim 1, wherein
said indicating tool detecting unit comprises a plurality of individual indicating tool detecting units, to said individual indicating tool detecting units identification information different from each other being assigned, respectively, and wherein
said signal output unit changes said drive signal based on said moving speed and identification information on an individual indicating tool detecting unit having detected existence of said indicating tool.

3. The input mechanism according to claim 2, wherein
said indicating tool detecting unit forms a peripheral shape of a polygon, and wherein
said plurality of individual indicating tool detecting units form a shape of a side of said polygon, respectively.

4. The input mechanism according to claim 1, further comprising:
a medium, arranged underneath said elastic member, capable of propagating a pressure applied to said elastic member; and
a chassis to store said medium, said pressing detection unit and said driving unit in its interior; wherein
said pressing detection unit detects said elastic member having been pressed via said medium.

5. The input mechanism according to claim 1, comprising:
a piezoelectric element, said piezoelectric element being said pressing detection unit and also being said driving unit;
upon said elastic member being pressed, said piezoelectric element being deformed by flexion and generating a voltage signal; and
said drive signal being a voltage signal.

6. The input mechanism according to claim 5, wherein
said signal output unit outputs said voltage signal to said piezoelectric element, only upon magnitude of a voltage signal occurring from said piezoelectric element exceeding a predetermined threshold value.

7. The input mechanism according to claim 5, wherein
said signal output unit changes, according to a moving speed calculated by said calculation unit, at least one of amplitude and a frequency of a voltage signal outputted to said piezoelectric element.

8. The input mechanism according to claim 1, wherein
said indicating tool detecting unit is a photoelectric sensor.

9. An input device comprising a plurality of input mechanisms according to claim 1.

10. An input mechanism control method, comprising:
an indicating tool detection step of detecting an indicating tool existing on a predetermined area;
a pressing detection step of detecting an elastic member, arranged in an area circled by said predetermined area, having been pressed;
a calculating step of calculating a moving speed of said indicating tool from a detection result by said indicating tool detection step and a detection result by said pressing detection step;
a signal output step of outputting a drive signal, upon detecting said elastic member having been pressed by said pressing detection step; and
a driving step of applying a force to the elastic member by carrying out driving based on the drive signal; wherein
said signal output step changes said drive signal based on a moving speed calculated by said calculating step.
